(19) United States
(12) Patent Application Publication
(10) Pub. No.: US 2006/0068896 A1
(43) Pub. Date: Mar. 30, 2006

(54) Method for improved on-line game bonus channel

(76) Inventor: Yu-Chin Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/940,725

(22) Filed: Sep. 15, 2004

(51) Int. Cl. A63F 13/00

(52) U.S. Cl. 463/25

(57) ABSTRACT

This specification discloses a design method for an improved online game bonus channel. Independent entrances separate the bonus channel mode from the ordinary mode. The invention utilizes the concept of tickets to limit the time a player can enter the bonus channel and the tickets are not accumulatable. Therefore, the player has to purchase a new ticket each time to enter the bonus channel. The bonus channel mode introduces a bonus mechanism, which is a random number processed operating mechanism that determines the compensation the player can obtain in the bonus channel. A message column is provided as a medium to notify the compensation obtained by the player in the bonus channel. Advertisements of sponsor companies can be posted in the message column too. Finally, a retrieving mechanism is established for the player to retrieve the compensation after finishing the bonus channel mode.

### BACKGROUND OF THE INVENTION

1. Field of Invention

The invention relates to a design method for an improved on-line game bonus channel and, in particular, to a design method for the bonus channel achieving both the fun of games and the effect of advertisements.

2. Related Art

On-line games prosper with the prevalence of broadband networks. Hundreds of on-line games are available on the market. As shown in FIG. 1, the game company 2 introduces the concept of “trade account points 111 for merchandises 23” to attract players 1 to use the game interface 22. The account points generally refer to the game points (obtained by purchasing game cards), experience points (obtained during the games) and virtual money (obtained during the games). However, merchandises 23 favored by players 1 usually ask for more points 111. For players 1 with little leisure time or worse playing skill, it is practically impossible for them to accumulate the points 111. Therefore, such players are less willing to play such complicated games.

Moreover, some players 1 own more than one account. One may have two accounts 11, 12 so that he or she can transfer all points 121 in the account 12 to the account 11. Thus, it becomes unfair.

In view of these problems, how to attract players to play on-line games with fun game interfaces instead of letting players to simply go after points is an important issue.

### SUMMARY OF THE INVENTION

A primary objective of the invention is to provide a design method for an improved on-line game bonus channel, which establishes a game mode of betting small for big. The players thus have chances to obtain a higher compensation at a lower cost. This is the primary means to attract players.

Another objective of the invention is to provide a design method for an improved on-line game bonus channel, which establishes a quick and convenient game interface so that the player does not need to spend too much time in collecting points while enjoying the fun at the same time.

A further objective of the invention is to provide a design method for an improved on-line game bonus channel, which establishes an operation mode of cooperation between different businesses to enlarge the effects of advertisements, increasing the investment in the bonus channel.

To achieve the above objectives, the invention establishes a bonus channel entrance on the basis of the original game interface, separating the ordinary game mode from the disclosed bonus channel mode. The login platform is improved at the same time to include a detection function to prevent players from using an external program and to verify the player's identity, thereby ensuring the safety and stability of the game. The invention provides a ticket design to restrict the time a player can enter. The tickets are not able to be accumulated. This can prevent the situation where a player owns several accounts to transfer and accumulate points as in ordinary on-line games, rendering the game fairer. The invention adopts a bonus mechanism, which uses a random number operation to evaluate the compensation a player can obtain, achieving the fun of betting small for big. The player may be able to gain a lot without paying much. The compensation can be real merchandises, game points, coupons, or prizes in any other form. The invention also provides a retrieving mechanism for the player to obtain the compensation from the bonus channel. The compensation is sent by the game company or sponsor companies. The invention provides a display column to display the compensation a player obtains in the bonus channel and advertisements of the sponsors or the game company. Through cooperation with a different business, the advertisement effects will be enlarged to attract more investments.

### BRIEF DESCRIPTION OF THE DRAWINGS

The present invention will become more fully understood from the detailed description given herein below illustration only, and thus are not limitations of the present invention, and wherein:

FIG. 1 is a prior art schematic block diagram of trading merchandises in an on-line game; and

FIG. 2 is a schematic block diagram of how to implement the bonus channel and how to obtain the compensation.

### DETAILED DESCRIPTION OF THE INVENTION

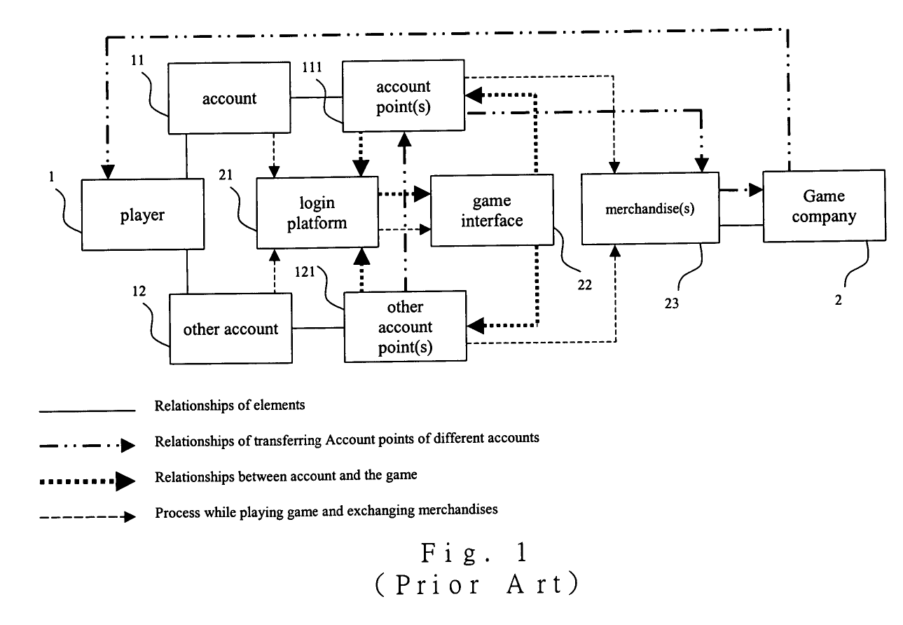

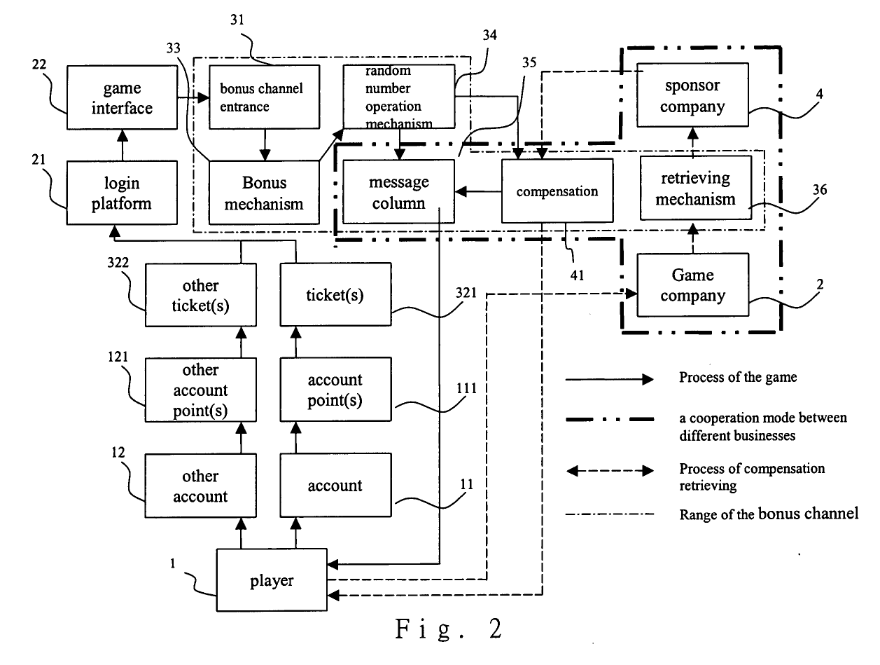

The disclosed design method for an improved on-line game bonus channel 3 is shown in FIG. 2. According to the invention, a bonus channel 3 mechanism is established on the basis of the game interface 22 of an ordinary on-line game. The medium to the bonus channel 3 is the so-called bonus channel entrance 31. In view of the problem that ordinary on-line games only have login platforms 21 but not any managing mechanism, the invention lets the game company 2 to independently manage the login platform 21. The functions of the login platform 21 is modified to effectively detect whether a player 1 uses an external program and to verify the player's identity, ensuring the safety during the game and the stability in the system operation. The player 1 plays the game from the same starting point as others. His or her record is not affected by any external factor. Therefore, the login platform 31 also ensures the fairness. The installation of the bonus channel entrance 31 increases the universality of all games. First, the provision of individual entrances for the games avoids the trouble of modifying programs all the time. Secondly, the bonus channel entrance 31 does not affect the operation of the ordinary mode. The bonus channel 3 is based upon the ordinary game interface 22. In the ordinary mode shown in FIG. 2, the player 1 uses the same account 11 and the same game interface 22 to enter the bonus channel 3 using the following mechanism, enjoying a different fun from that in FIG. 1.

The invention provides a ticket 321, which through modifying the file access privilege executes a specific program (i.e., the bonus channel 3 of the invention). From the player's point of view, it looks like he or she really owns an entrance ticket. The ticket 321 costs the player's account points 111. To satisfy the “betting small for big” design, the price of ticket 321 is usually set not too high. When the player 1 selects to enter the bonus channel mode, it is like buying an item under the ordinary mode. The account 11 is not affect except losing some points 111. However, the ticket 321 to the bonus channel 3 gives the player 1 a chance to obtain a good compensation 41, including real merchandises, game points, coupons, and prizes in other forms, at a small cost. This is a main feature to attract players 1. The tickets 321 are not able to be accumulated. That is, such things as the playing time and the life in each ticket 321 are fixed and independent. Each ticket 321 has its using time and limits. This prevents the player 1 from owning several accounts and transferring or accumulating points or tools, as in the ordinary mode. Due to the time limit and the “non-accumulating property” of the disclosed ticket 321, it is perfectly fine for the same player 1 to own another ticket 322 because that is bought by the player 1. Of course, the player 1 has more chances to gain compensations. The ticket 321 and the other ticket 322 are sold through the game interface 22. The game company 2 can have the following design: (1) the two or more tickets are for different times if the purchaser is the same player; (2) once the player 1 has the choice of battles after using the ticket 321 to enter, the game interface 22 automatically pair the opponents. Therefore, the game only cares about the tickets but the players, pretty much in the same way as the lotteries. This design basically ensures the fairness for the player 1 because it is the player 1 who determines to buy more or fewer tickets for more or fewer chances.

The invention adopts a bonus mechanism 33, which is a random number operation mechanism 34. Its primary function is to perform a simple random number processing to produce random, unpredictable effects. Used in the disclosed bonus channel 3, it determines whether the player 1 can obtain certain compensation 41. The compensation 41 is provided by the sponsor company 4 or the game company 2. Since the compensation 41 randomly appears under the control of the bonus mechanism 33, the player 1 does not know what prize to get each time. He or she may not be able to get any compensation throughout the game, but also may be able to gain a lot in the end. The compensation 41 can be changed according to the sponsor companies 4 and the new projects of the game company 2. Thus, each ticket 321 is a new fun and chance for the player 1. Such an idea and uncertainty bring more fun to the player 1.

Finally, a message column 35 is provided to display the compensation 41 that the player 1 has obtained, reminding the player 1 to collect at the end of each game. The message column 35 can further display the picture(s) of the compensation 41 and the relative information of the sponsor company 4 or the game company 2 (including trademark logos, text descriptions, sponsor contact information, sales, etc). Originally, the high compensation 41 provided by the sponsor company 4 and the game company 2 is used as an attraction for players 1. In the end, it achieves more advertisement effects. Therefore, it is an advantage of the cooperation between different businesses. The compensation retrieval is achieved using a retrieving mechanism 36. The retrieving mechanism 36 may be provided by the game company 2, or the sponsor company 4 can send the compensation 41 directly to the player 1. This is also a cooperation mode between different businesses. Repeated uses of the above-mentioned means can increase the attraction factors for the bonus channel 3 for more players 1 to participate.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A design method for an improved on-line game bonus channel, comprising the steps of:
establishing a bonus channel mode entrance on the basis of an existing game interface;
providing a bonus mechanism, which randomly determines a compensation that a player obtains under the bonus channel mode;
providing a message column, which displays the compensation obtained by the player in the bonus channel; and
providing a retrieving mechanism, which enables the player to obtain the compensation.

2. The design method of claim 1, wherein the player has to use a ticket to enter the bonus channel entrance.

3. The design method of claim 2, wherein the ticket is purchased using account points of the player.

4. The design method of claim 2, wherein the ticket has the restriction of playing time and is not able to be accumulated.

5. The design method of claim 3, wherein the account points include game points, experience points, and virtual money.

6. The design method of claim 1, wherein the compensation is selected from the group comprising real merchandises, game points, coupons, and prizes in other forms.

7. The design method of claim 6, wherein the compensations in the bonus mechanism are provided by the sponsor company and the game company.

8. The design method of claim 1, wherein the message column further displays advertisements of the sponsor company and the game company.

9. The design method of claim 7, wherein the sponsor company is not restricted to certain business and operates independently without affecting the establishment of the bonus channel.

10. The design method of claim 8, wherein the sponsor company is not restricted to certain business and operates independently without affecting the establishment of the bonus channel.
